(19) United States
(12) Patent Application Publication
(10) Pub. No.: US 2023/0124502 A1
(43) Pub. Date: Apr. 20, 2023

(54) HAMMER BUSHINGS WITH SOFTENED OUTER REGION

(71) Applicant: Caterpillar Inc., Peoria, IL (US)

(72) Inventors: Curtis Andrew Henning, Dunlap, IL (US); Cody Moore, Lorena, TX (US); Michael Alan Pershing, Washington, IL (US); Robert Jason Pickerill, Peoria, IL (US)

(73) Assignee: Caterpillar Inc., Peoria, IL (US)

(21) Appl. No.: 17/503,006

(22) Filed: Oct. 15, 2021

(51) Int. Cl. B25D 9/12; F16F 13/14; C21D 9/00

(52) U.S. Cl. CPC B25D 9/12; F16F 13/14; C21D 9/0068

(57) ABSTRACT

An example bushing of a hydraulic hammer tool includes an outer region and an inner region. The inner region has a relatively greater hardness than the outer region. The inner region may also be compressively stressed, while the outer region may have tensile stress. The stress and/or hardness profile of the bushing may enhance its resistance to wear and galling defects when a hammer of the hydraulic hammer tool is held in alignment by the bushing. The outer region of the bushing may be relatively soft, resulting in the bushing having a relatively high level of toughness. The bushing may be formed using medium to high carbon steel by rough forming the bushing, hardening the bushing, tempering the bushing, and induction softening the outer region of the bushing.

### TECHNICAL FIELD

The present disclosure relates to formation of steel components. More specifically, the present disclosure relates to hammer bushings or other tubular components formed with a relatively soft outer region proximal to an outer surface.

### BACKGROUND

Machines are in widespread use in construction, mining, forestry, and other similar industries. These machines often include a variety of tools thereon, such as a hydraulic hammer tool or hydraulic breaker. The hydraulic hammer tool is used to repeatedly impact objects, such as concrete, with a hammer to break-up or demolish the object. For example, a hydraulic hammer tool may be provided on an excavator and used to break through a portion of road (e.g., asphalt) or sidewalk (e.g., concrete). The hydraulic hammer tool includes a hammer with a head that impacts objects that are to be hammered. The hammer moves up and down within a housing of the hydraulic hammer tool and is generally kept in alignment by a bushing of the hydraulic hammer tool.

The hammer, therefore, is in contact with the bushing and, during use, imparts forces onto the bushing. As a result, the hammer imparts tribological wear on the inner surface of the bushing. Such hydraulic hammer tools can operate in extremely adverse environments in which hydraulic hammer tools, and the components therein, may be exposed to various abrasive mixtures of water, dirt, sand, rock or other mineral or chemical elements. Thus, hydraulic hammer tools, operating under harsh conditions, may grind the inner diameter of the bushing, resulting in reduced lifetime of the bushing components. Wear of the bushings results in having to replace the bushings that can involve costly in-the-field downtime and maintenance.

Due to the consequences of excessive wear on the inner surface of the bushings, it is desirable to have a relatively hard inner diameter of the bushings. This improves the wear resistance of the bushing and its operable lifetime. However, if the entirety of the bushing is hardened, the bushing may be relatively less tough and may crack during use. Thus, it is desirable to have a bushing with a relatively hard inner region, proximal to the inner surface and a relatively soft outer region proximal to the outer surface.

An example of producing a bushing with a relatively high level of inner surface hardness is described in U.S. Pat. No. 10,493,610 (hereinafter referred to as the '610 reference), where a bushing with surface hardening by carburization is disclosed. For example, the bushing may be subject to a carburizing treatment, followed by a quench and tempering treatment. However, this process of the '610 reference includes additional steps, such as a carburizing process, which add processing time and cost in the manufacture of the bushings. Additionally, in this process of steel surface hardening, as described in the '610 reference, specialized equipment may be required to perform the carburization process.

Example embodiments of the present disclosure are directed toward overcoming the deficiencies described above.

### SUMMARY

In an example of the disclosure, a bushing includes an inner surface, an outer surface, and an outer region disposed between the inner surface and the outer surface, the outer region proximal to the outer surface, the outer region having an outer region carbon concentration. The bushing further includes an inner region disposed between the inner surface and the outer surface, the inner region proximal to the inner surface, the inner region having an inner region carbon concentration. The bushing still further includes an intermediate region disposed between the inner region and the outer region, wherein the inner region has a hardness of at least about 60 Rockwell Hardness Scale C (HRC), the outer region has a hardness in the range of about 35 HRC to about 45 HRC, the intermediate region has a hardness in the range of about 45 HRC to about 60 HRC, and the inner region carbon concentration and the outer region carbon concentration are substantially the same.

In another example of the disclosure, a method of manufacturing a bushing includes forming a rough bushing with steel having a carbon content greater than about 0.58% by weight, the rough bushing having an inner surface and an outer surface opposing the inner surface. The method further includes heating the rough bushing to a temperature of at least about 800° C., quenching the rough bushing directly from the temperature at which the heating is performed to form a hardened bushing, and tempering the bushing in a range of about 100° C. to about 400° C. The method still further includes induction heating the hardened bushing along the outer surface to form the bushing with an outer region proximal to the outer surface, the outer region softer than the inner surface of the bushing.

In still another example of the disclosure, a machine includes a component that includes an inner surface and an outer surface. The component further includes an outer region disposed between the inner surface and the outer surface, the outer region proximal to the outer surface, the outer region having an outer region carbon concentration. The component still further includes an inner region disposed between the inner surface and the outer surface, the inner region proximal to the inner surface, the inner region having an inner region carbon concentration. The component yet further includes an intermediate region disposed between the inner region and the outer region, wherein the inner region has a hardness of at least about 60 HRC, the outer region has a hardness in the range of about 35 HRC to about 45 HRC, the intermediate region has a hardness in the range of about 45 HRC to about 60 HRC, and the inner region carbon concentration and the outer region carbon concentration are substantially the same.

### BRIEF DESCRIPTION OF DRAWINGS

FIG. 1 is a schematic illustration of an example machine with one or more components formed in accordance with examples of the disclosure.

FIG. 2 is a schematic semi-transparent illustration of an example hydraulic hammer tool of the machine as depicted in FIG. 1, according to examples of the disclosure.

FIG. 3 is a schematic sectional semi-transparent illustration of the hydraulic hammer tool as depicted in FIG. 2, according to examples of the disclosure.

FIG. 4 is a schematic semi-transparent illustration of a bushing of the hydraulic hammer tool as depicted in FIG. 2, according to examples of the disclosure.

FIG. 5 is a flow diagram depicting an example method for forming an example bushing as depicted in FIG. 4 with a relatively hard inner portion proximal to an inner surface of the bushing and a relatively softer outer portion proximal to the outer surface of the bushing, according to examples of the disclosure.

FIG. 6 is an example sectional illustration of the bushing depicted in FIG. 4, according to examples of the disclosure.

FIG. 7 is another example sectional illustration of the bushing depicted in FIG. 4, according to examples of the disclosure.

FIG. 8 is another example sectional illustration, along with an example hardness profile, of the bushing depicted in FIG. 4, according to examples of the disclosure.

### DETAILED DESCRIPTION

Wherever possible, the same reference numbers will be used throughout the drawings to refer to the same or like parts.

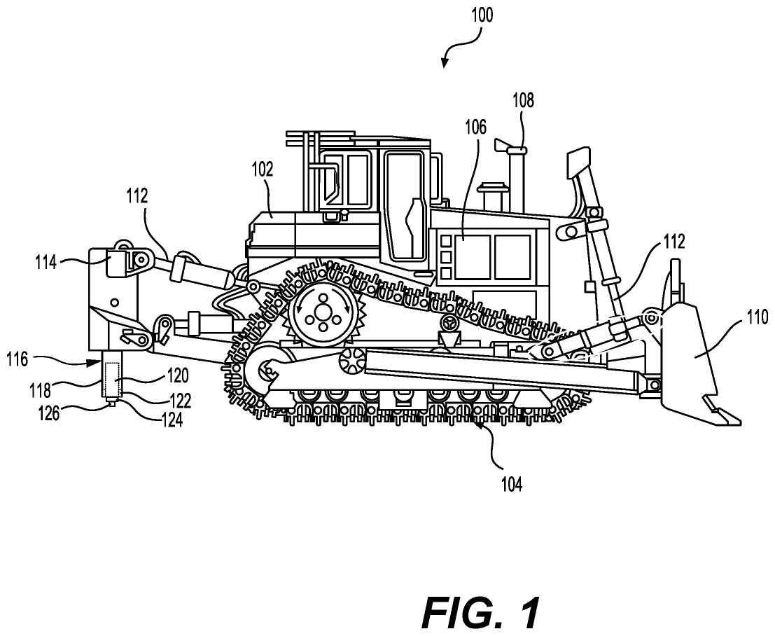

FIG. 1 is a schematic illustration of an example machine 100 with one or more components formed in accordance with examples of the disclosure. Although the machine 100 is depicted as a dozer, it should be understood that the machine 100 may be of any suitable type, such as those used in construction, farming, mining, transportation, or the like. In other examples, the machine 100 may be any suitable machine 100, such as, a loader, an excavator, a tank, a backhoe, a drilling machine, a trencher, a combine, or any other on-highway or off-highway vehicle.

The machine 100 includes a frame 102 on which other elements of the machine 100 are mounted. The machine 100 includes a propulsion system 104, such as a track chain assembly, as shown. Alternatively, the machine 100 may have any other suitable type of propulsion system 104, such as wheels and tires. The machine 100 further includes an engine 106, such as an internal combustion engine powered by hydrocarbon fuels. Alternatively, the machine 100 may be an electrically powered machine. The machine 100 includes an exhaust system 108 and/or one or more work systems 110 that may be movable by one or more hydraulic systems 112. The machine 100 may also include a transmission system (not shown) that mechanically couples the engine 106 to the propulsion system 104. According to examples of the disclosure, any component of the machine 100, including any variety of components of the propulsion system 104, the engine 106, the exhaust system 108, the work systems 110, the hydraulic systems 112, the transmission, etc., may be formed by the mechanisms disclosed herein. Additionally, any of the aforementioned components of the machine 100 may have the structure and the resultant material properties as disclosed herein, when formed by the mechanisms disclosed herein.

The machine 100 may further include a mount 114 that may be attached to the hydraulic system 112 to hold a hydraulic hammer tool 116, which may also be referred to as a hydraulic breaker tool. The hydraulic hammer tool 116 may be used to break material that needs to be removed, such as in a construction setting. Thus, the hydraulic hammer tool 116 may be used to break rocks, concrete, asphalt, boulders, walls, glass, ceramics, or the like. The hydraulic hammer tool 116 may be used to break materials in applications where it may be unsafe and/or impractical to use other mechanisms (e.g., explosives) for demolition and/or breaking. In other cases, the hydraulic hammer tool 116 may be used in other applications that rely on percussion hammering, such as pile driving. An operator (not shown) of the machine 100 may be able to use any variety of controls, such as a foot paddle, to control the hydraulic hammer tool 116.

The hydraulic hammer tool 116 may include a frame 118 within which a hammer 120 of the hydraulic hammer tool 116 is disposed. The hammer 120 may be aligned within a bushing 122 of a tubular shape and configured to hold and align the hammer 120 within the frame 118 of the hydraulic hammer tool 116. The hammer 120 may include a protruded region 124 that protrudes from the frame 118. In some cases, there may be a hammer head 126 at an end of the hammer 120. When in use, the hammer head 126 may make contact and provide percussive impact on the material that is to be broken by the hydraulic hammer tool 116. In some cases, the hydraulic hammer tool 116 may not have a hammer head 126 as depicted here. Instead, the end of the hammer 120 may be substantially the same or similar dimensions as the rest of the hammer 120. In other cases, the hammer head 126 may be a different shape than what is depicted in FIG. 1. For example, in some cases, the hammer 120 may have a tapered end, a partially-tapered end, a moil point end, a narrow chisel end, a wide chisel end, or any other suitable shape that may make contact and provide percussive impact on the material that is to be broken by the hydraulic hammer tool 116.

The hydraulic hammer tool 116 may operate by modulating a pressurized fluid within the hydraulic hammer tool 116 to move the hammer 120 within the confines of the bushing 122. As a result, the proportion of the hammer 120 that is the protruded region 124, sticking out of the frame 118, varies when the hydraulic hammer tool 116 is in use. When the hammer 120 is fully extended and exerting force on the material to be broken, the protruded region 124 is maximum. Similarly, when the hammer 120 is fully retracted and may be pulling away from the material to be broken, the protruded region 124 is minimum. It is this reciprocating cyclic movement (e.g., up and down) that provides the percussive force to break the objects that are to be broken during use of the hydraulic hammer tool 116.

As the hammer 120 cycles up and down during use of the hydraulic hammer tool 116, the hammer 120 may have a variety of forces imparted thereon, including lateral forces that may arise from impact with the material that is to be broken. Therefore, the bushing 122 provides a guide for holding the hammer 120 in alignment when in use. The bushing 122 has a tubular shape and the hammer 120 has a cylindrical shape and is configured to fit through the bushing 122. As the hammer 120 moves axially, or up and down along its length during use, lateral forces, such as in a radial and/or lateral direction may be imparted to the hammer 120. The bushing 122 contacts the outer surface of the hammer 120 and, therefore, provides counter forces to the lateral forces that are imparted to the hammer 120 during use of the hydraulic hammer tool 116.

Since the bushing 122 is in contact with the hammer 120 and often has relatively significant forces imparted along its inner surface by the hammer 120, the bushing 122 may be subject to various failures. In general, the movement of the hammer 120 may wear out the inner surface of the bushing 122 that is in contact with the outer surface of the hammer 120. In more extreme cases, the bushing 122 may experience galling defects due to the reciprocating movement of the hammer 120 while in contact with the bushing 122.

The bushing 122, due to the conditions under which it operates, may wear out on a regular basis. Therefore, the bushing 122 may be replaced on a regular basis and/or on a maintenance schedule, as it wears out during the use of the hydraulic hammer tool 116. For example, the bushing 122 may be designed to operate until a particular level of wear is experienced on its inner diameter, such as about 1 millimeter (mm) to about 5 mm radially on the inner diameter. Although the bushing 122, in some cases, may be a consumable part, regular maintenance and replacement of the bushing 122 results in downtime at a construction or mining site, as well as a cost (e.g., parts cost, labor cost, opportunity cost of downtime, etc.). Therefore, it is desirable to minimize the frequency of downtime resulting from replacement of the bushing 122 in the hydraulic hammer tool 116.

The bushing 122 may be more wear resistant and last longer between replacement if the portions (e.g., the inner diameter region) of the bushing 122 that are in contact with the hammer 120 are hard. However, hardening the entirety of the bushing 122 may result in reduced toughness of the bushing 122 and further may result in additional forces (e.g., repeated percussive forces) being imparted to the frame 118, which may degrade the frame 118 and/or other components of the hydraulic hammer tool 116. The disclosure herein provides a bushing 122 that is relatively wear resistant while maintaining a relatively high level of toughness.

The bushings 122, as disclosed herein, may have a hardness of greater than approximately 60 Rockwell Hardness Scale C (HRC) in regions proximal to its inner surface and may have a bulk hardness of about 35 HRC to about 45 HRC. This allows for a relatively hard, wear resistant region of the bushing 122 that contacts the outer portion of the hammer 120 and a relatively softer region the bushing 122 that is in contact with the frame 118 of the hydraulic hammer tool 116. In other cases, the bushing may have three zones: a hard inner region proximal to the inner surface of the bushing 122, a soft outer region proximal to the outer surface of the bushing 122, and an intermediary hardness region between the inner region and the outer region. In this case, the inner region may have a hardness greater than approximately 60 HRC, the outer region may have a hardness less than about 45 HRC, and the intermediary region may have a hardness in the range of about 45 HRC to about 60 HRC. It should be understood that the aforementioned hardness values are example values and that the disclosure herein contemplates other values outside of the ranges indicated.

In some cases, the bushing 122 may have a hardness profile that can be defined and/or approximated by any variety of suitable mathematical functions. For example, the hardness may be modeled as a logarithmic function with low hardness in the outer region, intermediate hardness in the intermediate region, and high hardness in the inner region. In this example, the hardness may start at under about 40 HRC or so near the outer surface, increase in a logarithmic manner, and reach greater than about 60 HRC in the inner region proximal to the inner diameter of the bushing 122. It should be understood that the aforementioned hardness values are example values and that the disclosure herein contemplates other values outside of the ranges indicated. The aforementioned logarithmic function is also an example, and indeed any suitable function may define the hardness profile of the bushing 122 including, but not limited to, exponential functions, polynomial functions, linear functions, quadratic functions, error functions, combinations thereof, or the like. In some cases, the hardness profile (e.g., the hardness of the steel from the outer surface to the inner surface) of the bushing 122 may be defined and/or modeled using a combination of mathematical functions. For example, in one case, the hardness may increase from under 40 HRC near the outer surface in a logarithmic fashion through the outer region and most of the intermediate region, and then increase linearly or have a relatively flat profile through the inner region of the bushing 122.

Although a particular size and type of hydraulic hammer tool 116 is depicted herein, it should be understood that this disclosure applies to any suitable hydraulic hammer tool 116 of any suitable size. For example, the bushing 122 and the methods of making the bushing 122 apply to smaller hydraulic hammer tools 116, such as human-held jackhammer tools, as well as larger hydraulic hammer tools 116 that may be used for pile driving large rods. It should also be understood that the bushing and/or the methods of making the same may be applied to other components of the machine 100. For example, the hydraulic system 112 may include cylinders that may be fabricated as described herein. As another example, bushings in the propulsion system 104 may also be fabricated according to the disclosure herein.

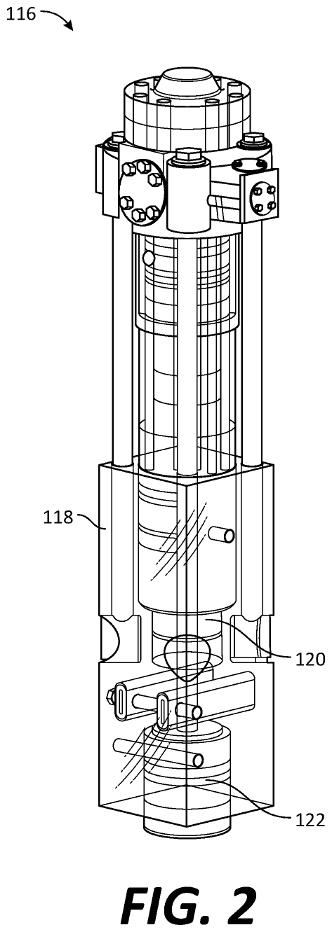

FIG. 2 is a schematic semi-transparent illustration of the hydraulic hammer tool 116 of the machine 100 as depicted in FIG. 1, according to examples of the disclosure. As shown, the hydraulic hammer tool 116 may include a variety of components that enable the movement of the hammer 120 within the frame 118 of the hydraulic hammer tool 116. The hammer 120 may have a cylindrical shape and may fit within the bushing 122, which is a tubular shape, at an exit end of the hydraulic hammer tool 116. In this way, the bushing 122 holds the hammer 120 in place, radially, as the hammer moves axially. Although lubricants, such as oil, may be used to reduce stiction, friction, and/or other tribological impediments, it should be appreciated that there will be a relatively high level of wear and tear on the bushing 122 when the hammer 120 moves within the interior of the bushing 122.

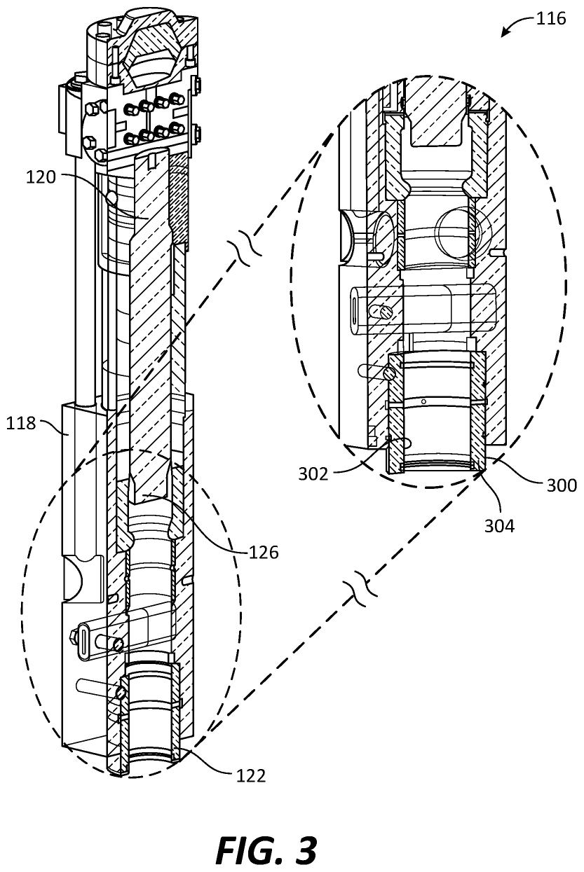

FIG. 3 is a schematic sectional semi-transparent illustration of the hydraulic hammer tool 116 as depicted in FIG. 2, according to examples of the disclosure. The bushing 122 may include an outer surface 300, an inner surface 302, and a bulk region 304. As shown, the bushing 122, in some examples, may contact the hammer 120 on its inner surface 302, and contact the frame 118 on its outer surface 300. Therefore, while forces are imparted to the bushing 122 by the hammer 120, the bushing 122, in turn, may impart forces to the frame 118. It is desirable to minimize the amount of force that is imparted to the frame 118 by the bushing 122. As a result, it is desirable to have the bushing 122 such that portions of the bulk region 304 and/or the outer surface 300 are relatively soft, ductile, and/or compressible, while a region proximal to the inner surface 302 is relatively hard. In this way, the bushing 122 provides relatively high wear resistance on its inner surface 302, while minimizing the amount of force imparted to the frame 118. The bushing 122 with a relatively softer bulk region 304 and/or outer surface 300, as disclosed herein, provides a relatively high toughness and high resistance to cracking.

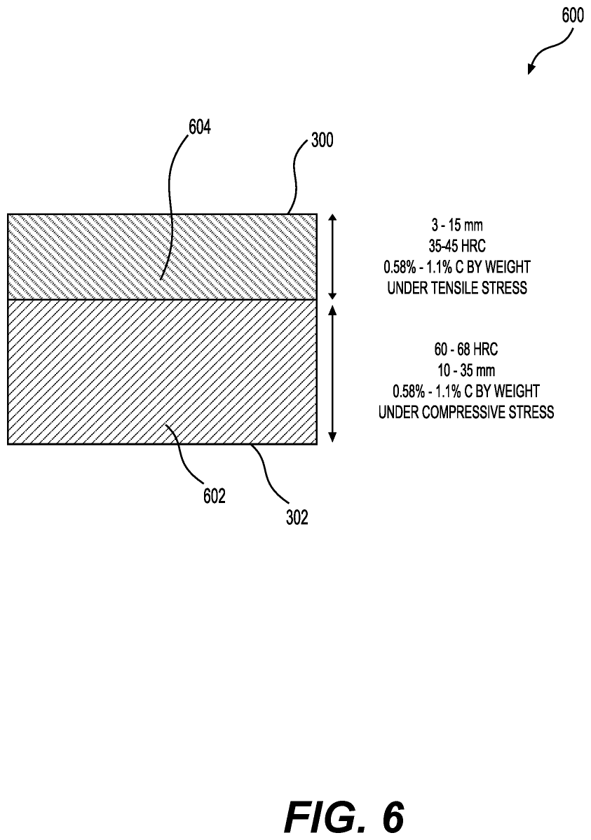

Although not shown here, and as described in greater detail in conjunction with FIGS. 6, 7, and 8, the bulk region 304 may include a variety of additional regions therein. For example, a region proximal to the inner surface 302 may have a hardness of greater than approximately 60 HRC and the remainder of the bulk region 304 and the outer surface 300 may have a hardness in the range of about 35 HRC to about 60 HRC. In some cases, the inner surface 302 may have a hardness of about 63 HRC or greater. In yet other cases, the inner surface may have a hardness of about 66 HRC or greater. In some cases, the bulk region 304 and/or the outer surface 300 may have a hardness in the range of about 37 HRC to about 43 HRC. In yet other cases, the bulk region 304 and/or the outer surface 300 may have a hardness in the range of about 39 HRC to about 41 HRC.

As discussed herein, the bulk region 304 may include three different regions of an inner region that is relatively hard, an outer region that is relatively soft, and an intermediate region between the inner region and the outer region that is intermediate in hardness between the inner region and the outer region. In this case, the inner region may have a hardness of greater than approximately 60 HRC, the outer region may have a hardness less than 45 HRC, and the intermediate region may have a hardness in the rage of about 45 HRC to about 60 HRC. In some cases, the inner region and/or the inner surface 302 may have a hardness of about 63 HRC or greater. In yet other cases, the inner region and/or the inner surface may have a hardness of about 66 HRC or greater. In some cases, the outer region and/or the outer surface 300 may have a hardness in the range of about 37 HRC to about 43 HRC. In yet other cases, the outer region and/or the outer surface 300 may have a hardness in the range of about 39 HRC to about 41 HRC. In some cases, the intermediate region may have a hardness profile that is continuous at the interfaces with the inner region and the outer region.

The bushing 122 may be constructed of medium to high carbon steel. For example, the carbon content of the steel may be in the range of about 0.58% by weight to about 1.1% by weight. According to examples of the disclosure, the bushing 122 may be rough formed, such as by one or more machining processes, and then hardened by heating and quenching. The bushing 122 may be tempered after the hardening process. The hardening process may form a bushing 122 that is hard throughout. Next, the bushing 122 may be tempered using an induction heating process proximal to the outer surface 300 to form a bushing 122 with a softened portion proximal to the outer surface 300. The induction heating process may heat a relatively small depth from the outer surface 300 of the bushing 122 to temperatures that temper and/or soften the steel. After induction heating, the bushing 122 may be cooled, such as by forced air cooling. The depth of the softened portion may about 5 mm to about 15 mm of depth from the outer surface that has a hardness of less than about 45 HRC. Thus, the bushing 122 has a hardness profile such that the region proximal to the inner surface 302 is relatively hard and the rest of the bushing 122 is relatively soft. Additionally, the relatively hard portion of the bushing 122 and the rest of the bushing 122 have substantially the same carbon concentrations. In some examples, the hard portion of the bushing 122 proximal to the inner surface 302 may be under compressive stress, while the rest of the bushing 122 may be under tensile stress.

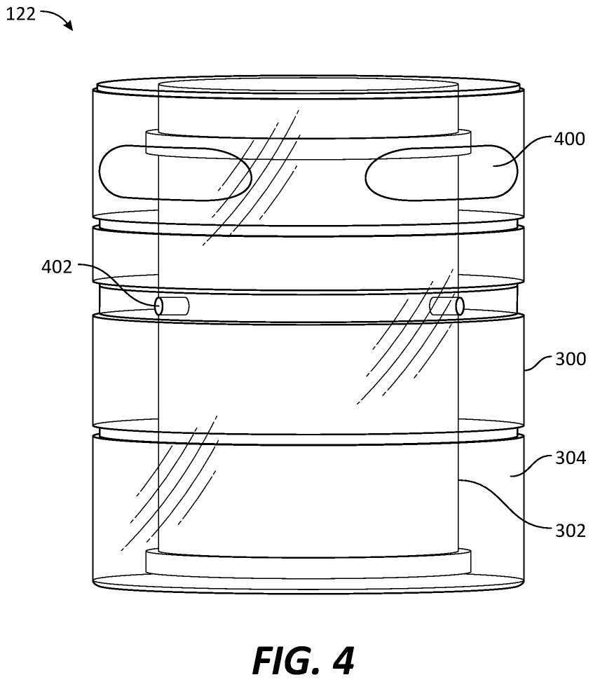

FIG. 4 is a schematic semi-transparent illustration of a bushing 122 of the hydraulic hammer tool 116 as depicted in FIG. 2, according to examples of the disclosure. The bushing 122 may include one or more features, such as bolt holes 400 and/or oil conduits 402. The bolt holes 400 may enable the bushing 122 to be fastened to another component of the hydraulic hammer tool 116, such as to the frame 118. The oil conduits 402 may allow for lubricants to wet the inner surface 302 of the bushing 122 during operation of the hydraulic hammer tool 116. There may be any number of other features and/or elements on/in the bushing 122, according to examples of the disclosure.

In some examples, the bushing 122 may have an inner diameter in a range of about 50 mm to about 200 mm. In some examples, the inner diameter of the bushing 122 may be in a range of about 100 mm to about 180 mm. The value of the inner diameter of the bushing 122 may depend in part on the size of the hydraulic hammer tool 116. For example, a large hydraulic hammer tool 116 mounted on an excavator may have a bushing 122 with an inner diameter in a range of about 125 mm to about 200 mm, while a bushing 122 for a smaller hydraulic hammer tool 116 mounted on a skid steer may have an inner diameter in a range of about 50 mm to about 125 mm. The wall thickness of the bushing 122 may be in the range of about 10 mm to about 50 mm. In some cases, the bushing 122 may have a wall thickness in the range of about 20 mm to about 35 mm. The bushing 122 may have an outer diameter in the range of about 70 mm to about 300 mm. The bushing 122 may have a length in a range of about 100 mm to about 300 mm. Although specific dimensional ranges are discussed herein, it should be understood that the disclosure herein applies to dimensional ranges outside of those discussed.

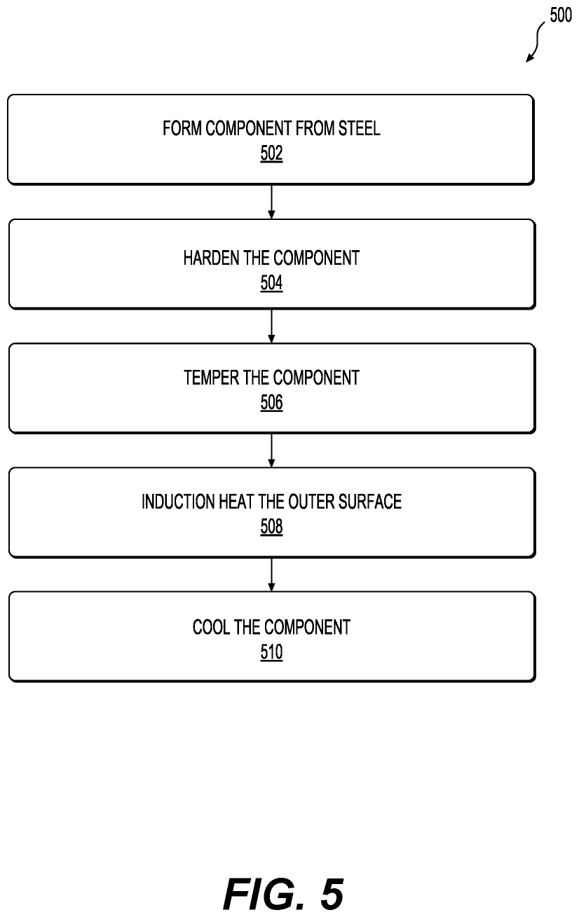

FIG. 5 is a flow diagram depicting an example method 500 for forming the bushing 122 as depicted in FIG. 4 with a relatively hard inner region proximal to the inner surface 302 of the bushing 122 and a relatively softer outer portion proximal to the outer surface 300 of the bushing 122, according to examples of the disclosure. Although the method 500 is described in the context of a bushing 122 for the hydraulic hammer tool 116, it should be appreciated that method 500 may be used to form other components of machine 100, such as other tubular shaped components that benefit from a relatively hard inner surface region.

At block 502, the component may be formed from steel. The forming of the component may include rough forming the component, such as the bushing 122. Rough forming, as used herein, refers to forming the shape of a component, prior to subsequent thermal treatments, such as strengthening via thermal processing, such as annealing, quenching, etc. or tempering. The bushing 122 may be formed from medium-carbon and/or high-carbon steel. Any variety of suitable alloy steel, spring steel, bearing steel, medium carbon steel, and/or high carbon steel may be used to rough form the bushing 122. For example, American Iron and Steel and Institute (AISI) 5160 steel may be used to rough form the bushing 122. As another example, AISI 52100 steel may be used to rough form the bushing 122.

A rough formed component, such as the bushing 122, may be formed from medium carbon (C) steel and/or high carbon steel, with C content in the range of about 0.58% to about 1.1% by weight. The steel used to rough form the component may be any suitable crystal structure, such as ferrite, pearlite, cementite, bainite, spheroidal carbide, martensite, austenite, and/or the like. The steel may include a variety of other impurities and/or additives therein. For example, components of the machine 100 may be formed from steel that may further include other elements therein, such as manganese (Mn), phosphorus (P), sulfur (S), silicon (Si), chromium, (Cr), boron (B), cobalt (Co), molybdenum (Mo), nickel (Ni), titanium (Ti), tungsten (W), niobium (Nb), vanadium (V), combinations thereof, or the like. It should also be noted that in some examples, the composition of the steel may be relatively uniform throughout.

In some examples, the steel used to rough form the components, such as bushing 122, may include C in the range of about 0.56% to about 0.64% by weight, Mn in the range of about 0.7% to about 1% by weight, Si in the range of about 0% to about 0.3% by weight, P in the range of about 0% to about 0.05% by weight, S in the range of about 0% to about 0.05% by weight, and Cr in the range of about 0.65% to about 0.95% by weight. In other examples, the steel used to rough form the components, as discussed herein, may include C in the range of about 0.9% to about 1.1% by weight, Mn in the range of about 0.25% to about 0.7% by weight, Si in the range of about 0.1% to about 0.4% by weight, P in the range of about 0% to about 0.04% by weight, S in the range of about 0% to about 0.03% by weight, Ni in the range of about 0% to about 0.3% by weight, Cr in the range of about 1% to about 1.7% by weight, and Mo in the range of about 0% to about 0.15% by weight. It should be understood that the disclosure herein contemplates using steel with compositions outside of the aforementioned ranges.

The concentrations of additives and/or impurities in the steel, as discussed herein, may allow for the formation of the structures, as discussed in conjunction with FIG. 4. For example, the metallurgical concentrations discussed herein may be well suited to form a hard inner region of the bushing 122 proximal to the inner surface 302 and a relatively soft outer region proximal to the outer surface 300. In other words, the relatively hard, compressively stressed inner surface 302 with the relatively softer bulk region 304 and outer surface 300 that is under tensile stress may be formed using the chemical concentrations of the steel, as discussed herein. However, other metallurgical compositions other than the ones discussed herein, with individual elemental compositions greater or less than those listed or with additional or fewer elemental additives, may also provide structures similar to those discussed in conjunction with FIG. 4 and FIG. 6. As disclosed above, the configuration of the hardness profile of the bushing 122, as enabled by the chemical compositions disclosed herein, provides a relatively high level of durability, and therefore greater lifetime of the bushing 122, when subject to harsh operating conditions.

The initial medium or high carbon steel may be relatively soft and ductile, allowing for relatively easy rough formation of the component, such as the bushing 122. For example, the steel may have an initial hardness in the range of about 33 HRC to about 50 HRC. The component, during rough formation, may be any suitable crystal structure, such as ferrite, pearlite, bainite, cementite, spheroidal carbide, martensite, and/or austenite. In some cases, if the starting steel is not sufficiently soft, then a tempering process may be performed. In examples, the tempering process may be conducted at an under the carbon-steel eutectic temperature for a multi-hour anneal prior to forming the rough component. For example, the steel may be held at a range between about 300° C. to about 600° C. for about 30 minutes to about 5 hours to temper the steel prior to rough forming the component. The temperature and/or time ranges here, and throughout the disclosure, are examples, and temperatures and time periods shorter or longer may be used in accordance with examples of the disclosure.

The component, such as the bushing 122, may be formed by any suitable mechanism such as any suitable hot formation mechanism and/or machining technique. In some cases, the bushing may be rough formed by starting with bar stock steel, such as cylindrical bar stock steel and machining the bar stock steel. In these cases, the starting bar stock steel may be of a cylindrical shape, or any other suitable shape. The bar stock steel may be of any suitable type and/or composition. As discussed herein, in some cases, the bar stock steel may be AISI 5160, AISI 52100, or the like. The bar stock steel may be bored out and then milled on a lathe to form the bushing 122. Other types of machining, such as shaping, turning, milling, drilling, grinding, chiseling, lathing, and/or combinations thereof may also be performed on the bored out and milled steel to rough form bushing 122.

In some other cases, the bushing 122 may be rough formed by any variety of hot processes. For example, any type of casting, rolling, hot rolling, cold rolling, extrusion, combinations thereof, or the like may be used to form the rough component. Additionally or alternatively, the rough component may be formed by any variety of subsequent machining techniques suitable for forming the component, such as any type of shaping, turning, milling, drilling, grinding, chiseling, lathing, and/or other machining techniques.

At block 504, the component may be hardened. In some examples, this hardening process may include heating the component to a relatively high temperature and then quenching the component. The component, such as the bushing 122, may be heated to a range of about 760° C. to about 1100° C. In some cases, the bushing 122 may be heated to a range of about 800° C. to about 1000° C. In yet other cases, the bushing may be heated to a range of about 850° C. to about 950° C. The component may be held at temperature for about 30 minutes to about 3 hours. In some cases, the heating process may be a batch process, where more than one component of the machine 100 may be heated simultaneously. In some cases, the induction heating may be performed in a reducing and/or non-oxidizing ambient, such as in a nitrogen containing environment, a forming gas environment, an ammonia environment, an argon environment, combinations thereof, or the like.

After the heating process, the component, such as bushing 122, may be quenched. In some cases, the quenching may be performed as an oil quench. In other cases, other quenching mechanisms may be used, such as water quench, polymer quench, air quench, etc. In some examples, the component may be cooled at a rate of approximately between about 2° C./s (or 120° C./min) and about 6° C./s (or 360° C./min). After the quench, the rough component may have a substantially martensitic crystal structure. The rough component, after the quench may have a hardness greater than 60 HRC throughout the component. In some cases, the component may have a hardness greater than 63 HRC throughout, after the quench. In yet other cases, the component may have a hardness greater than 66 HRC throughout, after the quench. Because the component is substantially uniformly hard throughout, further processing may be performed to soften the hardness of the component, such as proximal to the outer surface 300, by way of the following processes of method 500.

At block 506, the component may be tempered. This tempering process may be conducted as a furnace tempering process and/or an induction tempering process at a temperature in the range of about 100° C. to about 400° C. This tempering process may reduce the possibility of cracking, such as delayed cracking, in the hardened bushing 122, particularly proximal to the inner surface 302.

At block 508, the outer surface may be induction heated. This process of induction heating the outer surface 300 and the region proximal to the outer surface 300, tempers and/or softens the outer surface 300 and the regions proximal to the outer surface 300 of the component. Thus, the induction heating may selectively temper the outer portion of the component, such that the inner portions of the component are relatively harder than the outer portions of the component. This heating may be performed in an induction furnace, where induction coils are used to heat a particular depth into the bushing 122 at the inner surface 302. In some cases, this induction furnace process may be performed in a non-oxidizing and/or reducing ambient (e.g., nitrogen ambient, argon ambient, etc.). In examples, the outer surface 300 may be heated to a softening temperature at a particular depth from the outer surface 300, such as a depth of about 1 mm to about 15 mm. In some cases, the softening depth may be approximately in the range of about 5 mm to about 10 mm. In examples of the disclosure, the tempering process may be conducted at a particular temperature, such as within a range of about 400° C. to about 700° C. In some cases, the steel may be held at a temperature range between about 550° C. and about 650° C. at the outer surface 300. In some examples, the tempering conditions (e.g., temperature, ambient, time) may be based at least in part on the composition of the steel.

The induction heating may be performed for any suitable length of time and at any suitable power and frequency of operation to provide the desired thickness of the hardened inner region proximal to the outer surface 300. For example, the induction heating may be performed for a time of about 5 seconds to about 10 minutes. The induction heating may be performed at any suitable frequency to achieve the desired depth of softness of the outer region proximal to the outer surface 300, such as about 3 kilohertz (kHz) to about 10 kHz. The induction heating process on the outer surface 300 may lead to the component having a substantially tempered martensitic and/or spheroidal carbide crystal structure in an outer region proximal to the outer surface 300. At this point, the tempered component may have a hardness in the range of about 35 HRC to about 45 HRC proximal to the outer surface 300, such as at a depth of about 5 mm to about 15 mm into the bushing 122 at the outer surface 300.

At block 510, the component may be cooled. In some cases, the component may be left to sit in atmospheric ambient to cool the component. In other cases, the component may be cooled by forced air cooling. During the cooling process, the component may be cooled from the induction heating temperature (e.g., between about 400° C. and about 700° C.) to less than 200° C. In other cases, during the cooling process, the component may be cooled from the induction heating temperature to near room temperature.

It should be appreciated that after performing method 500, the inner region of the bushing 122, proximal to the inner surface 302, may be substantially martensitic and/or spheroidal carbide in crystal structure. In other words, the quenching process may result in a relatively high level of martensite crystal structure in the hardened region near the inner surface 302 of the bushing 122. This martensitic texture, combined with the relatively high carbon content of the steel results in a hardening of the region near the inner surface 302. The bulk region 304 proximal to the outer surface 300, on the other hand, may be substantially tempered martensitic in crystal structure after the induction heating of the outer surface 300. Thus, the inner surface 302, as disclosed herein, may be harder than the bulk region 304 and/or the outer surface 300 of the component. Additionally, the inner region proximal to the inner surface 302 may be in compressive stress, while the bulk region 304 may be in tensile stress. Thus, method 500, individually or in combination with the metallurgical compositions described herein, allows for the formation of the advantageous structure of the bushing 122, thereby enhancing the wear resistance, durability, and lifetime of the bushing 122.

It should be noted that some of the operations of method 500 may be performed out of the order presented, with additional elements, and/or without some elements. For example, in some cases, an optional tempering process may be performed after cooling the component, or simultaneously with cooling the component, at block 510. In such a process, the component may be held at a temperature in the range of about 100° C. to about 400° C. Some of the operations of method 500 may further take place substantially concurrently and, therefore, may conclude in an order different from the order of operations shown above. Although certain processes are discussed with respect to method 500, it should be understood that there may be other processes implemented in addition to the processes listed here. In these cases, other processes, such as hard-facing, may be used to thicken inner region. Indeed, any suitable processes may be performed prior to or after the processes of method 500.

FIG. 6 is an illustration of a sectional face 600 of the bushing 122 depicted in FIG. 4, according to examples of the disclosure. This sectional view depicts the hardness and stress profile of the bushing 122 after the bushing 122 is formed according to method 500 and the metallurgical compositions disclosed herein. The bushing 122 may have an inner region 602 proximal to the inner surface 302 and an outer region 604 and outer surface 300, as disclosed herein. The formation of the component with the inner region 602 may be enabled by the relatively high carbon concentration in the steel along with the induction heating and quenching near the outer surface 300 of the bushing 122. It should also be noted that the discussion herein may apply to any of the components of the machine 100, particularly other tubular components, as described in conjunction with FIG. 1, as well as components manufactured for other applications and/or industries.

As discussed herein, the inner region 602 may also be referred to as a hard inner layer. Similarly, the outer region 604 may also be referred to as a soft outer region, core layer, and/or soft region. Although the inner region 602 and the outer region 604 are depicted as having a sharp transition, it should be understood that in some cases the transition from the inner region 602 to the outer region 604 may be graded and/or gradual. In other words, there may be a spatial transition region that embodies material properties intermediate between the inner region 602 and the outer region 604. In some cases, the transition thickness between the inner region 602 and the bulk region 304 may range from about 200 micrometers (μm) to about 20 mm.

According to examples of the disclosure, the inner region 602 may be substantially martensitic in crystal structure, while the outer region 604 may also be martensitic in crystal structure. However, the outer region 604 may be a tempered martensite crystal structure, due to the induction heating performed near the outer surface 300. Thus, the inner region 602 may be harder than the outer region 604 of the bushing 122. The metallurgical concentrations, including carbon, may be substantially uniform throughout the bushing 122. In other words, the carbon content in the inner region 602 may be substantially the same as the carbon concentration in the outer region 604.

As discussed herein, the inner region 602 may have a hardness of greater than approximately 60 HRC and the outer region 604 and the outer surface 300 may have a hardness in the range of about 35 HRC to about 45 HRC. In some cases, the inner region 602 may have a hardness of about 63 HRC or greater. In yet other cases, the inner region 602 may have a hardness of about 66 HRC or greater. In some cases, the outer region 604 and/or the outer surface 300 may have a hardness in the range of about 37 HRC to about 43 HRC. In yet other cases, the outer region 604 and/or the outer surface 300 may have a hardness in the range of about 39 HRC to about 41 HRC.

It should also be understood that the properties of the inner region 602 may not be uniform throughout the thickness of the inner region 602. In some cases, the presence of the inner region 602 may be detected by measuring the hardness at a threshold depth into the inner region 602. For example, the hardness at a depth of approximately 500 μm into the inner region 602 may be in the range of approximately 60 HRC to about 65 HRC. In some cases, the hardness at a depth of approximately 500 μm into the inner region 602 may be in the range of approximately 62 HRC to about 66 HRC. For example, in some cases, the hardness at a depth of 500 μm into the inner region 602 may be approximately a minimum of 60 HRC.

Similar to the inner region 602, it should also be understood that the properties of the outer region 604 may not be uniform throughout the thickness of the outer region 604. In some cases, the presence of the outer region 604 may be detected by measuring the hardness at a threshold depth into the outer region 604. For example, the hardness at a depth of approximately 500 μm into the outer region 604 may be in the range of approximately 35 HRC to about 45 HRC. In some cases, the hardness at a depth of approximately 500 μm into the outer region 604 may be in the range of approximately 36 HRC to about 40 HRC. For example, in some cases, the hardness at a depth of 500 μm into the inner region 602 may be approximately a maximum of 40 HRC.

The inner region 602 may be of any suitable thickness. For example, the inner region 602 may be a thickness in the range of about 10 mm to about 35 mm. In some other cases, the thickness of the inner region 602 may be in the range of approximately 15 mm to about 25 mm. Although the disclosure discusses certain thicknesses of the inner region 602 herein, it should be understood that the disclosure contemplates thicknesses outside of the ranges discussed herein. It should also be understood that the thickness of the inner region 602 may vary based at least in part on the component and/or the application of the component. For example, for a larger bushing 122, a thicker inner region 602 may be desired compared to that for a smaller bushing 122. The outer region 604 may have a thickness in the range of about 3 mm to about 15 mm.

The inner region 602 is not just harder, but in some cases, the inner region 602 is also in compressive stress, while the outer region 604 is in tensile stress. Thus, by engineering this component such that the maximum forces are imparted to a compressively stressed region, such as the inner region 602, a lower possibility of cracking can be achieved, leading to greater durability of the bushing 122. In addition to the advantageous stress profile described herein, the enhanced hardness of the inner region 602 improves its durability to impacts, such as impacts at elevated operating temperatures.

It should be understood that the structure of the bushing 122, as depicted in FIG. 6, can be fabricated using the material compositions and/or the processes disclosed herein. The bushing 122, as fabricated, may provide enhanced resistance to wear, cracking, galling, and/or fracturing. Thus, the hardness profile and/or the stress profile of the bushing 122 may provide overall improved durability and lifetime of the bushing 122.

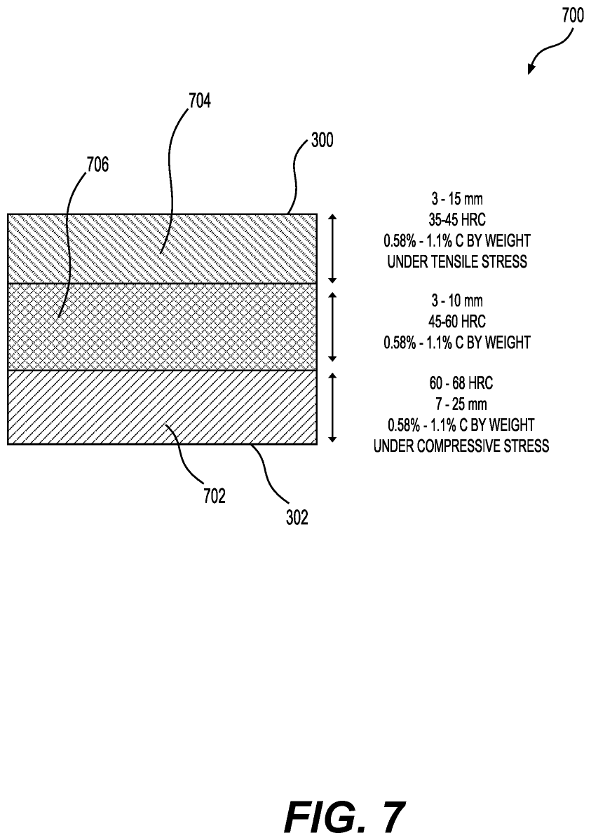

FIG. 7 is another example sectional face 700 of the bushing 122 depicted in FIG. 4, according to examples of the disclosure. This sectional view depicts the hardness and stress profile of the bushing 122 after the bushing 122 is formed according to method 500 and the metallurgical compositions disclosed herein. The bushing 122 may have an inner region 702 proximal to the inner surface 302 and an outer region 704 and outer surface 300, as disclosed herein. Additionally, the sectional face 700 may include an intermediate region 706 disposed between the inner region 702 and the outer region 704. The formation of the component with the inner region 702 may be enabled by the relatively high carbon concentration in the steel along with the induction heating and quenching near the outer surface 300 of the bushing 122. Similarly, the outer region may be formed from the induction heating of the component near the outer surface 300. It should also be noted that the discussion herein may apply to any of the components of the machine 100, particularly other tubular components, as described in conjunction with FIG. 1, as well as components manufactured for other applications and/or industries.

Although the inner region 702, the intermediate region 706, and the outer region 704 are depicted as having sharp transitions, it should be understood that in some cases the transition from the inner region 702 to the intermediate region 706, and the transition from the intermediate region 706 to the outer region 704, each may be graded and/or gradual. According to examples of the disclosure, the inner region 702 may be substantially martensitic in crystal structure, while the outer region 704 may also be martensitic in crystal structure. However, the outer region 704 may be a tempered martensite crystal structure, due to the induction heating performed near the outer surface 300. The intermediate region 706 may have a tempering profile intermediate between the inner region 702 and the outer region 704. Thus, the inner region 702 may be harder than the outer region 704 of the bushing 122. The metallurgical concentrations, including carbon, may be substantially uniform throughout the bushing 122. In other words, the carbon content in the inner region 702, the intermediate region 706, and the outer region 704 may have substantially the same carbon concentration.

As discussed herein, the inner region 702 may have a hardness of greater than approximately 60 HRC and the outer region 704 and the outer surface 300 may have a hardness in the range of about 35 HRC to about 45 HRC. In some cases, the inner region 702 may have a hardness of about 63 HRC or greater. In yet other cases, the inner region 702 may have a hardness of about 66 HRC or greater. In some cases, the outer region 704 and/or the outer surface 300 may have a hardness in the range of about 37 HRC to about 43 HRC. In yet other cases, the outer region 704 and/or the outer surface 300 may have a hardness in the range of about 39 HRC to about 41 HRC. The intermediate region 706 may have a hardness in the range of about 45 HRC to about 60 HRC.

The inner region 702 may be of any suitable thickness. For example, the inner region 702 may be a thickness in the range of about 7 mm to about 25 mm. In some other cases, the thickness of the inner region 702 may be in the range of approximately 10 mm to about 15 mm. Although the disclosure discusses certain thicknesses of the inner region 702 herein, it should be understood that the disclosure contemplates thicknesses outside of the ranges discussed herein. It should also be understood that the thickness of the inner region 702 may vary based at least in part on the component and/or the application of the component. For example, for a larger bushing 122, a thicker inner region 702 may be desired compared to that for a smaller bushing 122. The outer region 704 may have a thickness in the range of about 3 mm to about 15 mm. In some cases, the outer region 704 may have a thickness in the range of about 5 mm to about 10 mm. The intermediate region may have a thickness in the range of about 3 mm to about 10 mm.

It should be understood that the structure of the bushing 122, as depicted in FIG. 7, can be fabricated using the material compositions and/or the processes disclosed herein. The bushing 122, as fabricated, may provide enhanced resistance to wear, cracking, galling, and/or fracturing. Thus, the hardness profile and/or the stress profile of the bushing 122 may provide overall improved durability and lifetime of the bushing 122.

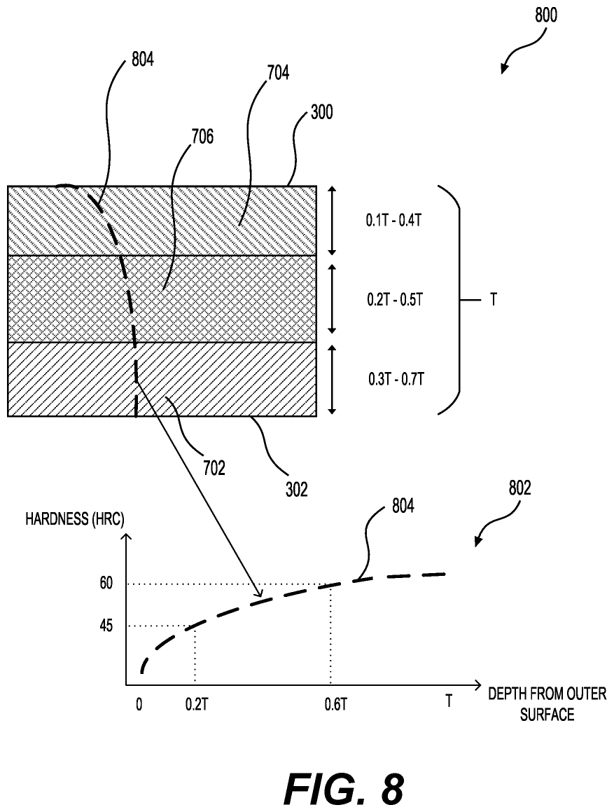

FIG. 8 is another example sectional face 800, along with an example hardness profile graph 802, of the bushing 122 depicted in FIG. 4, according to examples of the disclosure. In this illustration, the total thickness of the sectional face 800 may be T, where T may be any suitable thickness, such as a thickness in the range of about 13 mm to about 50 mm. As shown, the inner region 702 may be about 30% to about 70% of the overall thickness (T) of the bushing 122. The outer region 704 may be in the range of about 10% to about 40% of the overall thickness (T) of the bushing 122. The intermediate region 706 may be in the range of about 20% to about 50% of the overall thickness (T) of the bushing 122.

One example hardness profile 804 is depicted, as overlaid on the sectional face 800. The hardness profile may start at a relatively low hardness near the outer surface 300, such as in the range of about 35 HRC to about 40 HRC, and rise throughout the outer region 704 and the intermediate region 706. The hardness profile may somewhat flatten at a higher value within the inner region 702. In this example, the hardness may be about 45 HRC at a depth of about 20% of the overall thickness (T) of the bushing 122 and the hardness may be about 60 HRC at a dept of about 60% of the overall thickness (T) of the bushing 122. Although the hardness profile 804 is depicted as a logarithmic function, it should be appreciated that any suitable function may define the hardness profile 804 of the bushing 122 including, but not limited to, exponential functions, polynomial functions, linear functions, quadratic functions, error functions, combinations thereof, or the like.

It should be understood that the structure of the bushing 122, as depicted in FIG. 8, can be fabricated using the material compositions and/or the processes disclosed herein. The bushing 122, as fabricated, may provide enhanced resistance to wear, cracking, galling, and/or fracturing. Thus, the hardness profile and/or the stress profile of the bushing 122 may provide overall improved durability and lifetime of the bushing 122.

### INDUSTRIAL APPLICABILITY

The present disclosure describes systems, structures, and methods to increase wear tolerance, reduce crack initiation and/or crack propagation, and/or increase the toughness of components for machines 100 and/or any variety of hydraulic hammer tools 116, such as bushing 122. The bushing 122, as disclosed herein, may have a hard, wear-resistant inner region 602, as well as a soft outer region 604. The soft outer region 604 provides for a high level of toughness of the bushing 122, while the hard inner region 602 provides for a high level of wear resistance during operation of the hydraulic hammer tool 116. Additionally, the inner region 602 may be under compressive stress, thereby inhibiting crack formation and/or crack propagation, while the soft outer region 604 may be under tensile stress.

As a result of the systems, apparatus, and methods described herein, parts of machines 100, such as bushing 122, may have a greater lifetime. For example, the bushing 122 described herein may have greater service lifetime than traditional bushings that are not formed by the mechanisms described herein. In some cases, components, such as the bushing 122, may allow for a significant improvement in the wear lifetime of parts of the machines 100. This reduces field downtime, reduces the frequency of servicing and maintenance, and overall reduces the cost of heavy equipment, such as machines 100. The improved reliability and reduced field-level downtime also improves the user experience such that the machine 100 can be devoted to its intended purpose (e.g., construction, mining, etc.) for longer times and for an overall greater percentage of its lifetime. Improved machine 100 uptime and reduced scheduled maintenance may allow for more efficient deployment of resources (e.g., fewer, but more reliable machines 100 at a construction site). Thus, the technologies disclosed herein improve the efficiency of project resources (e.g., construction resources, mining resources, etc.), provide greater uptime of project resources, and improves the financial performance of project resources.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. The term “about” is used herein to describe a value that can be up to 10% higher or lower, according to context, than the value recited. All methods described herein can be performed in any suitable order unless otherwise indicated herein.

The drawings are illustrative only and non-limiting. Items depicted therein are not necessarily to drawn to scale and the relative proportions of various components may not be uniform. The drawings may not reflect certain dimensions recited in this specification.

What is claimed is:

1. A bushing, comprising:
an inner surface;
an outer surface;
an outer region disposed between the inner surface and the outer surface, the outer region proximal to the outer surface, the outer region having an outer region carbon concentration; and
an inner region disposed between the inner surface and the outer surface, the inner region proximal to the inner surface, the inner region having an inner region carbon concentration; and
an intermediate region disposed between the inner region and the outer region, wherein the inner region has a hardness of at least about 60 Rockwell Hardness Scale C (HRC), the outer region has a hardness in the range of about 35 HRC to about 45 HRC, the intermediate region has a hardness in the range of about 45 HRC to about 60 HRC, and the inner region carbon concentration and the outer region carbon concentration are substantially the same.

2. The bushing of claim 1, wherein the outer region carbon concentration is in a range of about 0.58% by weight and about 1.1% by weight and the inner region carbon concentration is in the range of about 0.58% by weight and about 1.1% by weight.

3. The bushing of claim 1, wherein a thickness of the inner region is in a range of about 7 millimeters (mm) to about 25 mm.

4. The bushing of claim 1, wherein the outer region has a thickness in a range of about 3 mm to about 15 mm.

5. The bushing of claim 1, wherein the intermediate region has a thickness in a range of about 3 mm to about 10 mm.

6. The bushing of claim 1, wherein the inner region is under compressive stress and the outer region is under tensile stress.

7. The bushing of claim 1, wherein the outer region has a crystal structure including tempered martensite and spheroidal carbide.

8. The bushing of claim 1, wherein the bushing has an inner diameter in a range of about 100 mm to about 180 mm.

9. A method of manufacturing a bushing, comprising:
forming a rough bushing with steel having a carbon content greater than about 0.58% by weight, the rough bushing having an inner surface and an outer surface opposing the inner surface;
heating the rough bushing to a temperature of at least about 800° C.;
quenching the rough bushing directly from the temperature at which the heating is performed to form a hardened bushing;
tempering the bushing in a range of about 100° C. to about 400° C.; and
induction heating the hardened bushing along the outer surface to form the bushing with an outer region proximal to the outer surface, the outer region softer than the inner surface of the bushing.

10. The method of claim 9, wherein the steel includes one of American Iron and Steel and Institute (AISI) 5160 steel or AISI 52100 steel.

11. The method of claim 9, wherein quenching the rough bushing further comprises quenching the rough bushing in oil.

12. The method of claim 9, further comprising forced air cooling of the bushing.

13. The method of claim 9, wherein the inner surface comprises a hardness of at least 60 Rockwell Hardness Scale C (HRC).

14. The method of claim 9, wherein the outer region has a thickness in a range of about 3 mm to about 15 mm.

15. The method of claim 9, wherein a first carbon content in the outer region is substantially the same as a second carbon content in a remainder of the bushing.

16. The method of claim 9, wherein the outer region has a hardness in the range of about 35 HRC and about 45 HRC.

17. A machine comprising a component, wherein the component comprises:
an inner surface;
an outer surface;
an outer region disposed between the inner surface and the outer surface, the outer region proximal to the outer surface, the outer region having an outer region carbon concentration; and
an inner region disposed between the inner surface and the outer surface, the inner region proximal to the inner surface, the inner region having an inner region carbon concentration; and
an intermediate region disposed between the inner region and the outer region, wherein the inner region has a hardness of at least about 60 Rockwell Hardness Scale C (HRC), the outer region has a hardness in the range of about 35 HRC to about 45 HRC, the intermediate region has a hardness in the range of about 45 HRC to about 60 HRC, and the inner region carbon concentration and the outer region carbon concentration are substantially the same.

18. The machine of claim 17, wherein the inner region carbon concentration is in a range of about 0.58% by weight and about 1.1% by weight and the outer region carbon concentration is in the range of about 0.58% by weight and about 1.1% by weight.

19. The machine of claim 17, wherein a thickness of the inner region is in a range of about 7 millimeters (mm) to about 25 mm.

20. The machine of claim 17, wherein the component includes one of American Iron and Steel and Institute (AISI) 5160 steel or AISI 52100 steel.
